(19) United States
(12) Patent Application Publication
(10) Pub. No.: US 2026/0203095 A1
(43) Pub. Date: Jul. 16, 2026

(54) Closure-Based Operating System Architecture Defining Stabilized System Identity within a Structured Memory Architecture

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/556,679

(22) Filed: Mar. 4, 2026

(51) Int. Cl. G06F 9/48

(52) U.S. Cl. CPC G06F 9/48

(57) ABSTRACT

A closure-based operating system architecture defines stabilized system identity within a structured memory architecture maintaining structural expressions and intrinsic structural relations. A closure stabilization component forms closure entities representing structurally stabilized system states, each closure entity including a closure signature defining identity continuity across structural evolution. Closure entities are structurally constituted within the structured memory architecture and constitute operating-system-level identity distinct from transient runtime states. Execution participation is grounded in structurally admissible closure entities rather than procedural state transitions or rule-based control. Identity continuity arises from intrinsic structural relations and structural invariants preserved through closure signatures, enabling admissible execution, distributed participation, suspension, and migration while maintaining stabilized system identity independent of execution-driven mechanisms. The architecture thereby establishes a structural identity ontology for operating-system-level system states independent of execution-driven state transitions.

### CROSS-REFERENCE TO RELATED APPLICATIONS

This application relates to a family of applications directed to memory-native structural operating system architectures defining admissible computational existence through intrinsic structural relations within structured memory domains. Earlier applications establish structured memory architectures, admissible domain constitution, structural admissibility boundaries, reality admission kernels, lineage continuity, and governed fact expressions independent of execution-based workflows. The present application extends such frameworks by defining a closure-based state architecture in which stabilized system identity is structurally constituted within a structured memory architecture and governs admissible execution participation at the operating-system level.

### PRIOR ART

The following patents and published patent applications have been identified as publicly accessible references and are submitted in compliance with IDS disclosure obligations. Inclusion of any reference does not constitute an admission regarding relevance to patentability.

This curated list emphasizes neighboring technical domains (checkpointing, virtual machine migration, distributed state synchronization, memory fabrics, disaggregated memory, lineage tracking) while avoiding direct structural overlap with the claimed closure entity, closure signature-based stabilized system identity, and closure-based execution gating architecture.

### US PATENT DOCUMENTS

U.S. Pat. No. 11,003,542 B1 May 2021 Kucherov et al.
U.S. Pat. No. 10,073,746 B2 September 2018 Blagodurov et al.
U.S. Pat. No. 11,429,379 B2 August 2022 Jain et al.
U.S. Pat. No. 11,409,619 B2 August 2022 Gopalan et al.
U.S. Pat. No. 9,977,688 B2 May 2018 Nipane et al.
U.S. Pat. No. 10,860,444 B2 December 2020 Natanzon
U.S. Pat. No. 9,621,643 B1 April 2017 Emelyanov
U.S. Pat. No. 12,021,690 B2 June 2024 Lian et al.
U.S. Pat. No. 10,379,966 B2 August 2019 Gangadharappa et al.
U.S. Pat. No. 10,747,630 B2 August 2020 Sanakkayala et al.
U.S. Pat. No. 8,856,593 B2 October 2014 Eckhardt et al.
U.S. Pat. No. 11,614,769 B2 March 2023 Ford
U.S. Pat. No. 9,659,042 B2 May 2017 Puri et al.
U.S. Pat. No. 9,075,860 B2 July 2015 Kozina et al.
US 20220398199 A1 December 2022 Calciu et al.
U.S. Pat. No. 9,262,225 B2 February 2016 Davis et al.
U.S. Pat. No. 10,073,809 B2 September 2018 Dinan et al.
U.S. Pat. No. 9,304,896 B2 April 2016 Chandra et al.
U.S. Pat. No. 10,235,063 B2 March 2019 Frank et al.
U.S. Pat. No. 9,971,506 B2 May 2018 Frank et al.
U.S. Pat. No. 10,698,628 B2 June 2020 Frank et al.
U.S. Pat. No. 10,922,005 B2 February 2021 Frank et al.
U.S. Pat. No. 11,231,865 B2 January 2022 Frank et al.
U.S. Pat. No. 11,461,263 B2 October2022 Malladi et al.
US 2023/0020462A 1 January 2023 Malladi et al.
U.S. Pat. No. 11,841,814 B2 December 2023 Malladi et al.
US 2024/0045823 A1 February 2024 Malladi et al.
US 2025/0004812 A1 January 2025 Radi et al.
US 2025/0036590 A1 January 2025 Malladi et al.
U.S. Pat. No. 10,031,819 B2 July 2018 Banerjee et al.
U.S. Pat. No. 8,539,488 B1 September 2013 Havemose

### FOREIGN PATENT DOCUMENTS

EP 3274861 B1 March 2021 Sharma et al.

### BACKGROUND OF THE INVENTION

Modern operating systems define system state primarily through runtime-oriented constructs, including process contexts, execution stacks, scheduler-managed states, container images, and virtual machine instances. Such mechanisms derive system identity from transient execution conditions, procedural transitions, or stored runtime data. Although checkpointing, snapshotting, and virtualization technologies may preserve operational state information, these approaches maintain data continuity rather than constitutionally defining stabilized system identity.

In conventional architectures, admissibility of execution participation is typically determined through rule-based access controls, policy engines, scheduling logic, or decision-based evaluation mechanisms. Structural admissibility is therefore indirectly enforced through procedural evaluation rather than arising inherently from intrinsic structural relations maintained within memory. As system complexity increases across distributed, heterogeneous, and low-compute environments, reliance on execution-driven identity and rule-based admissibility introduces architectural fragility and computational overhead.

Existing operating systems lack an architectural ontology in which system identity is structurally constituted through closure within a structured memory architecture governed by intrinsic structural relations. There remains a need for an operating system architecture in which stabilized system identity arises through structural constitution rather than through transient runtime state transitions, and in which execution participation is grounded in structural admissibility rather than procedural control.

### SUMMARY OF THE INVENTION

The present invention provides a closure-based operating system architecture in which stabilized system identity is structurally constituted within a structured memory architecture maintaining structural expressions and intrinsic structural relations. A closure stabilization component forms at least one closure entity representing a stabilized system state. Each closure entity includes a closure signature defining identity continuity of the stabilized system state across structural evolution.

Closure entities are structurally constituted within the structured memory architecture and represent operating-system-level state identity distinct from transient computational runtime states. Structural admissibility arises inherently from intrinsic structural relations maintained within the structured memory architecture, defining at least one admissible domain within which closure entities may be positioned.

Execution participation within the operating system is constitutionally grounded in closure entities representing structurally admissible stabilized states. An executable system state is constituted only upon structural presence of a closure entity within an admissible domain. Identity continuity is preserved through closure signatures reflecting structural invariants rather than through procedural enforcement, scheduling logic, or execution history. The architecture thereby defines an operating-system-level state ontology grounded in structural closure and identity continuity independent of execution-driven control mechanisms.

### BRIEF DESCRIPTION OF DRAWINGS

FIG. 1—Structured Memory and Closure Constitution

FIG. 2—Closure Signature and Identity Continuity

FIG. 3—Admissible Domain and Closure Participation

FIG. 4—Closure-Based Execution Architecture

FIG. 5—Distributed Closure Identity Continuity

### DETAILED DESCRIPTION OF THE INVENTION

The figures of this Section constitute expressive constitutional structural diagrams defining single-direction nested containment relations within a closure-based operating system architecture implemented on computational hardware. Each figure is organized as a single-direction nested structural hierarchy in which lower-numbered elements structurally contain higher-numbered elements. Directional positioning expresses constitutional containment and structural dependency only and shall not be interpreted as execution order, workflow sequence, algorithmic progression, scheduling behavior, enforcement logic, or decision-based control.

The coded elements of each figure form an inseparable constitutional structure in which structured memory architecture, intrinsic structural relations, closure stabilization, closure signature identity continuity, admissible domain constitution, and closure-based execution operate as a unified operating-system ontology. No element may be separated, bypassed, weakened, or rearranged to reinterpret the architecture as procedural, execution-driven, or algorithmically governed.

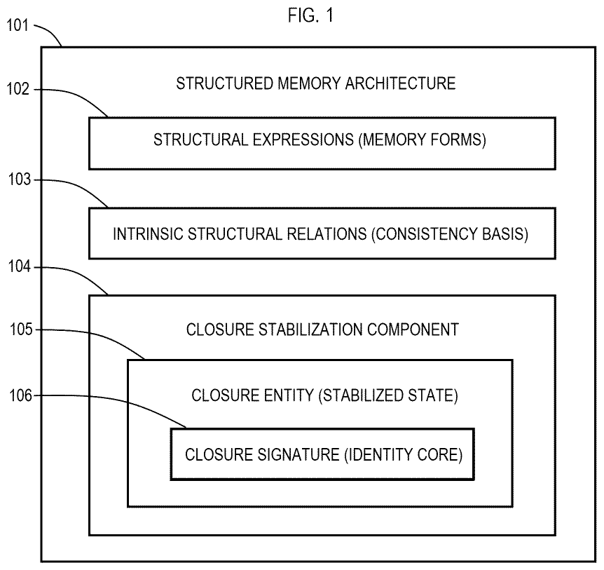

FIG. 1 illustrates a structured memory architecture (101) forming the outer constitutional structural domain. Nested within the structured memory architecture (101) are structural expressions (102) and intrinsic structural relations (103). Further nested within the structured memory architecture (101) is a closure stabilization component (104) structurally positioned relative to the structural expressions (102) and intrinsic structural relations (103). Nested within the structured memory architecture (101) and constituted through the structural positioning of the closure stabilization component (104) is at least one closure entity (105). Nested within the closure entity (105) is a closure signature (106) defining identity continuity of the stabilized system state. The nesting hierarchy is single-direction and continuous from 101 through 106, with each element structurally contained within the preceding architectural level.

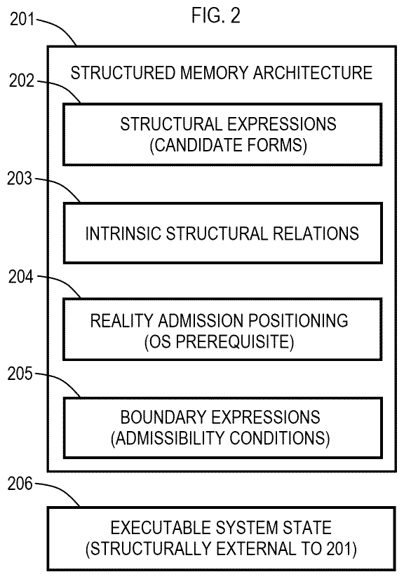

FIG. 2 illustrates a structured memory architecture (201) forming the outer containment domain. Nested within the structured memory architecture (201) is a closure entity (202) representing a stabilized system identity. Nested within the closure entity (202) is a closure signature (203) defining identity continuity across structural evolution. Nested within the structured memory architecture (201) and structurally reflected within the closure signature (203) are structural invariants (204) arising from intrinsic structural relations. Nested within the structured memory architecture (201) and structurally aligned with the closure entity (202) is a lineage continuity structure (205) representing continuity across successive stabilized identities. The figure preserves a single-direction nested containment structure in which each element is constitutionally positioned within the structured memory architecture (201).

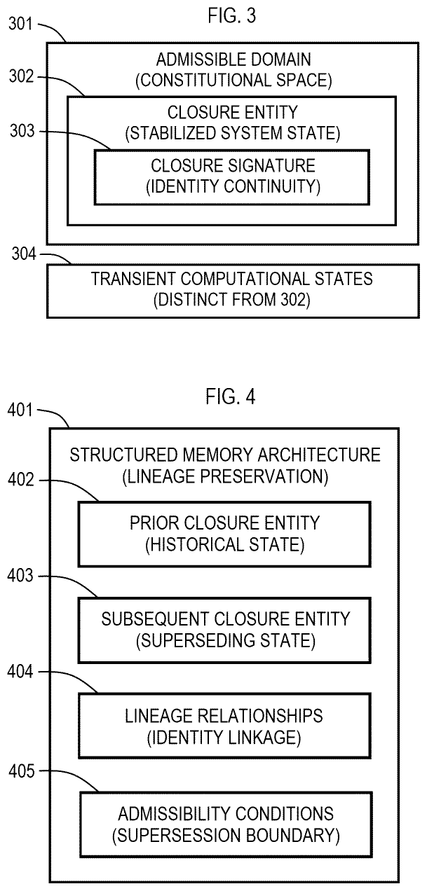

FIG. 3 illustrates a structured memory architecture (301) forming the outer structural domain. Nested within the structured memory architecture (301) is at least one admissible domain (302) arising from intrinsic structural relations. Nested within the admissible domain (302) is a closure entity (303) representing a structurally admissible stabilized system state. Structural expressions lacking structural admissibility (304) are positioned outside the admissible domain (302) but remain within the structured memory architecture (301). A closure-based participation boundary (305) is structurally defined by the containment relation between the admissible domain (302) and the surrounding structured memory architecture (301). The nesting direction proceeds from 301 to 302 to 303, preserving single-direction structural containment.

FIG. 4 illustrates a structured memory architecture (401) forming the outer constitutional domain. Nested within the structured memory architecture (401) is a closure entity (402) representing a stabilized admissible system identity. Nested within the structured memory architecture (401) and structurally positioned relative to the closure entity (402) is a closure-based execution framework (403). Nested within the closure-based execution framework (403) and constitutionally dependent upon the presence of the closure entity (402) is an executable system state (404). Transient runtime states (405) are positioned within the structured memory architecture (401) but outside the nested closure constitution defining operating-system-level identity. The structural nesting direction proceeds from 401 through 402 and 403 to 404 in a single-direction hierarchical containment structure.

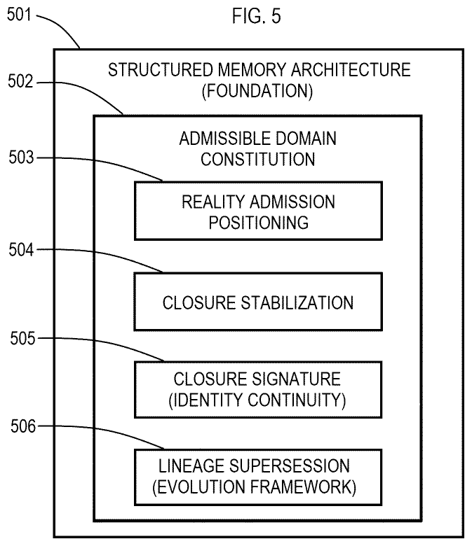

FIG. 5 illustrates a structured memory architecture (501) spanning distributed computational hardware as the outer structural domain. Nested within the structured memory architecture (501) are a first closure entity instance (502) and a second closure entity instance (503), each representing a stabilized system identity instance. Nested within each closure entity instance (502, 503) is a closure signature continuity relation (504) maintaining identity invariance across distributed structural positioning. A stabilized system identity (505) is constitutionally defined through the structural continuity maintained within the structured memory architecture (501). The figure preserves a single-direction nested containment hierarchy from 501 through 502/503 to 504 and 505, expressing distributed identity continuity without depicting operational sequencing.

All figures express constitutional structural nesting only. No figure represents operational flow, algorithmic execution, decision logic, or procedural coordination. The single-direction nested containment structure defines operating-system-level stabilized identity grounded in structural constitution within the structured memory architecture.

The following description provides detailed constitutional structural elaboration of the closure-based operating system architecture defined in Section 6A and the Claims. The description explains structural constitution, admissible positioning, identity continuity, and closure-based execution participation. The disclosed relations represent structural ontology within a structured memory architecture and shall not be interpreted as procedural steps, execution sequences, algorithmic routines, or enforcement mechanisms.

The architecture defines operating-system-level stabilized identity through structural closure constituted within a structured memory architecture maintaining intrinsic structural relations. Runtime manifestation arises from structural constitution rather than from execution-driven state transitions.

### I. Structured Memory Architecture and Structural Ontology

The operating system comprises a structured memory architecture maintaining structural expressions and intrinsic structural relations. Structural expressions may include candidate expressions, empirical expressions, boundary expressions, governance expressions, and factual expressions. Intrinsic structural relations define admissibility conditions among structural expressions within the structured memory domain.

The structured memory architecture constitutes a constitutional structural field in which admissible domains arise inherently from intrinsic structural relations. Structural admissibility is therefore determined by constitutional positioning within the memory architecture rather than by procedural evaluation or rule-based enforcement.

Within this architecture, structural stabilization may occur when structural expressions achieve consistency relative to intrinsic structural relations and admissibility conditions. Stabilization is structural in nature and does not require algorithmic decision logic or procedural transition sequencing.

### II. Closure Stabilization and Closure Entity Constitution

A closure stabilization component is structurally positioned within the structured memory architecture. The closure stabilization component forms at least one closure entity representing a stabilized system state. The closure entity is structurally constituted within the structured memory architecture and is not merely a runtime memory snapshot or transient execution context.

Closure formation arises through structural stabilization relative to intrinsic structural relations and structural admissibility conditions. Structural expressions lacking structural admissibility remain outside closure constitution without requiring procedural rejection, rule evaluation, or enforcement logic.

The closure entity includes a closure signature defining identity continuity of the stabilized system state. The closure signature reflects structural invariants arising from intrinsic structural relations maintained within the structured memory architecture. Identity continuity is therefore constitutionally grounded in structural invariants rather than derived from execution history or runtime state transition chains.

The closure entity constitutes an operating-system-level state identity distinct from transient computational states. Transient runtime data, scheduler context, or execution stacks do not themselves define system identity absent closure stabilization.

### III. Identity Continuity and Lineage Preservation

Identity continuity arises through the closure signature reflecting structural invariants preserved across structural evolution. Successive closure entities may arise within the structured memory architecture while maintaining lineage continuity through structural alignment of closure signatures.

Lineage continuity does not require replay of execution logs, reconstruction of procedural history, or enforcement-based validation. Instead, identity continuity is preserved by constitutional structural relations inherent within the structured memory architecture.

A stabilized system identity may therefore persist across suspension, resumption, migration, replication, or distributed participation, provided that closure signature continuity is structurally maintained. The identity of the operating-system-level state remains grounded in structural constitution rather than in node-specific runtime context.

### IV. Admissible Domain and Execution Participation

Intrinsic structural relations within the structured memory architecture define at least one admissible domain. Closure entities positioned within an admissible domain represent structurally admissible stabilized configurations.

Execution participation within the operating system is constitutionally grounded in closure entities representing admissible stabilized states. An executable system state arises only upon structural presence of a closure entity constituted within the admissible domain.

Transient runtime states may exist within the structured memory architecture but do not constitute operating-system-level identity absent closure stabilization. Execution scheduling, resource allocation, and runtime manifestation operate relative to closure-based identity rather than defining identity through procedural transitions.

The architecture thereby defines execution as structurally anchored in closure constitution rather than as a generator of system identity.

### V. Distributed and Low-Compute Implementations

The structured memory architecture may span distributed computational hardware including edge devices, low-compute environments, memory-disaggregated systems, and heterogeneous processing units. Closure entities may be constituted across distributed nodes while maintaining closure signature continuity.

Distributed closure entity instances may represent a unified stabilized system identity when closure signature continuity is structurally preserved. Identity invariance therefore does not depend upon centralized coordination or continuous execution-driven synchronization.

Because stabilized identity arises from structural constitution rather than from iterative decision pipelines or continuous rule evaluation, the architecture supports low-compute and edge-level environments by reducing dependency on persistent execution-based control mechanisms.

### VI. Representative Structural Cases

### Case 1—Suspension and Resumption

A closure entity representing a stabilized system identity is constituted within the structured memory architecture. Runtime activity may be suspended, resulting in transient execution state cessation. Upon resumption, closure signature continuity preserves operating-system-level identity independent of runtime memory contents, as identity is constitutionally grounded in closure stabilization rather than execution continuity.

### Case 2—Distributed Migration

A closure entity constituted within a first computational node is structurally replicated within a second node while preserving closure signature continuity. The stabilized system identity persists across nodes without reliance on procedural replay of execution history, because identity continuity is grounded in structural invariants maintained within the structured memory architecture.

### Case 3—Structural Evolution

A candidate structural expression becomes structurally admissible relative to intrinsic structural relations. Closure stabilization forms a successive closure entity aligned with structural invariants of the preceding closure entity. Identity continuity is preserved through closure signature alignment while allowing structural evolution of admissible system configuration.

### Case 4—Inadmissible Expression

A structural expression lacking structural admissibility remains outside closure constitution. No procedural rejection logic is required; exclusion arises inherently from absence of structural consistency relative to intrinsic structural relations.

### Case 5—Low-Compute Edge Device

An edge device operating with limited computational resources maintains a structured memory architecture defining intrinsic structural relations. Closure stabilization forms closure entities without requiring iterative decision engines or workflow orchestration. Execution participation arises from closure constitution, enabling stable system identity with reduced computational overhead.

### VII. Architectural Distinction

The disclosed architecture differs from conventional operating systems that define system state through transient runtime context, scheduler-managed execution stacks, container images, virtual machine snapshots, or procedural state machines. In contrast, the present architecture defines operating-system-level identity through structural closure constitution within a structured memory architecture governed by intrinsic structural relations.

Identity continuity is structurally constituted rather than procedurally enforced. Execution participation is constitutionally grounded in closure entities representing admissible stabilized states rather than in execution history or rule-based evaluation.

The architecture therefore establishes an operating-system-level state ontology grounded in structural stabilization and closure signature continuity within a structured memory domain.

1. A computational operating system implemented on computational hardware comprising at least one processing unit and at least one memory device, the system comprising:
a structured memory architecture stored in the at least one memory device and maintaining structural expressions and intrinsic structural relations;
a closure stabilization component executed by the at least one processing unit and configured to generate at least one closure entity representing a stabilized system state;
wherein the closure entity includes a closure signature defining identity continuity of the stabilized system state;
wherein closure entities are structurally constituted within the structured memory architecture stored in the at least one memory device;
wherein execution resources of the computational hardware are admitted upon structural presence of closure entities representing admissible stabilized states;
wherein closure formation occurs through structural stabilization within the structured memory architecture relative to intrinsic structural relations stored therein; and
wherein the closure entity constitutes an operating-system-level structural state identity distinct from transient computational runtime states maintained in volatile memory.

2. The computational operating system of claim 1, wherein the structured memory architecture spans logical memory structures, data-structural memory representations, and physical memory embodiments.

3. The computational operating system of claim 1, wherein structural expressions include candidate expressions, empirical expressions, boundary expressions, governance expressions, and factual expressions stored within the structured memory architecture.

4. The computational operating system of claim 1, wherein the closure stabilization component forms closure entities through structural consistency relative to intrinsic structural relations maintained within the structured memory architecture.

5. The computational operating system of claim 1, wherein the closure signature preserves identity continuity across system evolution without requiring procedural enforcement logic, rule engines, or algorithmic state-transition mechanisms.

6. The computational operating system of claim 1, wherein closure entities represent admissible stabilized configurations within at least one admissible domain defined by intrinsic structural relations.

7. The computational operating system of claim 1, wherein execution resources are allocated based on closure entities representing structurally stabilized states rather than transient runtime data states.

8. A computational operating system implemented on computational hardware comprising at least one processing unit and at least one memory device, the system comprising:
a structured memory architecture stored in the at least one memory device and maintaining structural expressions and intrinsic structural relations;
a closure stabilization component configured to generate closure entities representing stabilized system identities;
wherein each closure entity includes a closure signature defining identity continuity across structural evolution;
wherein closure entities are structurally constituted within the structured memory architecture;
wherein identity continuity is maintained through structural relations inherent to the structured memory architecture rather than procedural state transitions; and
wherein closure entities define operating-system-level identity anchors governing admissible participation in executable system states supported by the computational hardware.

9. The computational operating system of claim 8, wherein closure signatures maintain lineage continuity across successive stabilized system identities through preservation of structural invariants.

10. The computational operating system of claim 8, wherein closure entities enable reconstruction of stabilized system identity independent of transient computational context stored in volatile runtime memory.

11. The computational operating system of claim 8, wherein closure entities define governed fact expressions representing stabilized system reality within the structured memory architecture.

12. The computational operating system of claim 8, wherein closure identity continuity arises from intrinsic structural relations rather than externally imposed enforcement mechanisms.

13. The computational operating system of claim 8, wherein closure entities support distributed identity continuity across multiple computational nodes connected through networked hardware.

14. The computational operating system of claim 8, wherein closure stabilization excludes structurally inadmissible expressions without requiring algorithmic decision logic or rule-based rejection mechanisms.

15. A computational operating system implemented on computational hardware comprising at least one processing unit and at least one memory device, the system comprising:
a structured memory architecture stored in the at least one memory device and maintaining structural expressions and intrinsic structural relations;
a closure-based execution framework executed by the at least one processing unit and configured to admit execution states only upon formation of closure entities representing structurally stabilized admissible configurations;
wherein closure entities are structurally constituted within the structured memory architecture;
wherein closure entities define executable system identity distinct from transient computational runtime states;
wherein execution participation is governed by structural admissibility derived from intrinsic structural relations stored within the structured memory architecture; and
wherein closure entities constitute operating-system-level structural prerequisites for executable system states executed by the computational hardware.

16. The computational operating system of claim 15, wherein closure entities define admissible execution environments within at least one admissible domain.

17. The computational operating system of claim 15, wherein closure entities maintain structural identity invariants across system evolution through preservation of closure signatures.

18. The computational operating system of claim 15, wherein closure entities enable suspension and resumption of stabilized execution identity without loss of identity continuity.

19. The computational operating system of claim 15, wherein closure entities define structural identity boundaries arising from intrinsic structural relations maintained in memory.

20. The computational operating system of claim 15, wherein closure entities represent stabilized governed reality expressions within the operating system architecture.
